(19) United States
(12) Patent Application Publication
(10) Pub. No.: US 2011/0038588 A1
(43) Pub. Date: Feb. 17, 2011

(54) OPTICAL COUPLER

(75) Inventors: Duk Jun KIM, Daejeon (KR); Junghyung Pyo, Seoul (KR); Gyungock Kim, Seoul (KR)

Correspondence Address: AMPACC Law Group, PLLC, 6100 219th Street SW, Suite 580, Mountlake Terrace, WA, 98043, US

(73) Assignee: Electronics and Telecommunications Research Institute, Daejeon (KR)

(21) Appl. No.: 12/642,707

(22) Filed: Dec. 18, 2009

(30) Foreign Application Priority Data
Aug. 14, 2009 (KR) 10-2009-0075062

(51) Int. Cl. G02B 6/10

(52) U.S. Cl. 385/131

(57) ABSTRACT

Provided is an optical coupler. The optical coupler includes a lower cladding layer on a substrate, a core layer on the lower cladding layer, the core layer comprising a diffraction grating coupler and an optical waveguide, and an upper cladding layer on the core layer. The upper cladding layer has a thickness of about one quarter of a wavelength of an optical signal passing through the core layer divided by a refractive index of the first upper cladding layer. Thus, Fresnel reflection may be minimized, and also, it may prevent a Fabry-Perot interferometer from occurring.

### CROSS-REFERENCE TO RELATED APPLICATIONS

This U.S. non-provisional patent application claims priority under 35 U.S.C. §119 of Korean Patent Application No. 10-2009-0075062, filed on Aug. 14, 2009, the entire contents of which are hereby incorporated by reference.

### BACKGROUND

The present disclosure herein relates to an optical coupler, and more particularly, to an optical coupler including a diffraction grating coupler.

In order that lightwaves travel in a confined state without radiating the lightwaves to the outside due to a total internal reflection principal, a sectional structure in which a specific dielectric is surrounded by the other dielectric having a relatively low refractive index is required. A lightwave traveling path in which the sectional structure is maintained may be referred to as an optical waveguide. An optical fiber for communication is an exemplary example of the optical waveguide.

A dielectric constituting the optical waveguide and having a relative high refractive index is referred to as a core, and a dielectric surrounding the core and having a relative low refractive index is referred to as a cladding. The optical waveguide may be realized by applying the existing semiconductor process technology on a top surface of a substrate formed of a specific material such as silicon, silica (SiO₂), gallium-arsenic (GaAs), and indium phospide (InP). An optical device manufactured by such a manner is generally called a plate-type optical waveguide device. The greatest advantage of the optical waveguide device is that optical circuits that perform functions different from each other may be integrated on the same substrate. Thus, the optical waveguide may be variously modified in planar or sectional structure according to application of an optical circuit to be realized.

### SUMMARY OF THE INVENTIVE CONCEPT

Embodiments of the inventive concept provide an optical coupler in which light is minimally reflected by an upper cladding layer.

Embodiments of the inventive concept provide optical couplers including: a lower cladding layer on a substrate; a core layer on the lower cladding layer, the core layer including a diffraction grating coupler and an optical waveguide; and a first upper cladding layer on the core layer, wherein the first upper cladding layer has a thickness of about one quarter of a wavelength of an optical signal passing through the core layer divided by a refractive index of the first upper cladding layer.

In some embodiments, the optical couplers may further include a second upper cladding layer having a refractive index less than that of the first upper cladding layer on the first upper cladding layer.

In other embodiments, the core layer may have a refractive index greater than that of the first upper cladding layer.

In still other embodiments, the core layer may be formed of silicon, the first upper cladding layer may be formed of silicon nitride or silicon oxide-nitride, and the second upper cladding layer may be formed of silicon oxide.

In even other embodiments, the diffraction grating coupler may include a plurality of protrusions laterally spaced from each other.

In yet other embodiments, the optical couplers may further include a reflector disposed in the lower cladding layer. The reflector may have a flat plate shape parallel to a top surface of the substrate.

In still further embodiments, the optical couplers may further include a reflector disposed in the substrate. The reflector may have a flat plate shape parallel to a top surface of the substrate.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the figures:

FIG. 1 is a schematic view of an optical coupler according to an embodiment of the inventive concept;

FIG. 2 is a schematic view of an optical coupler according to another embodiment of the inventive concept;

FIG. 3 is a schematic view of an optical coupler according to another embodiment of the inventive concept;

FIG. 4 is a schematic view of an optical coupler according to a first modified example of the inventive concept;

FIG. 5 is a schematic view of an optical coupler according to a second modified example of the inventive concept;

FIG. 6 is a schematic view of an optical coupler according to a third modified example of the inventive concept; and

FIG. 7 is a schematic view of an optical coupler according to a fourth modified example of the inventive concept.

### DETAILED DESCRIPTION OF THE EMBODIMENTS

Preferred embodiments of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

It will be understood that although the terms first and second are used herein to describe various elements, these elements should not be limited by these terms. These terms are used only to discriminate one region or layer from another region or layer.

In the figures, the dimensions of layers and regions may be exaggerated for clarity of illustration. Like reference numerals refer to like elements throughout.

For convenience of description, several embodiments to which the spirit and scope of the inventive concept can be applicable are illustratively described below, and descriptions with respect to various modified embodiments will be omitted. However, it will be understood by those of ordinary skill in the art that various changes in form and details may be made therein without departing from the spirit and scope of the inventive concept, based on the above-descriptions and the illustrative embodiments.

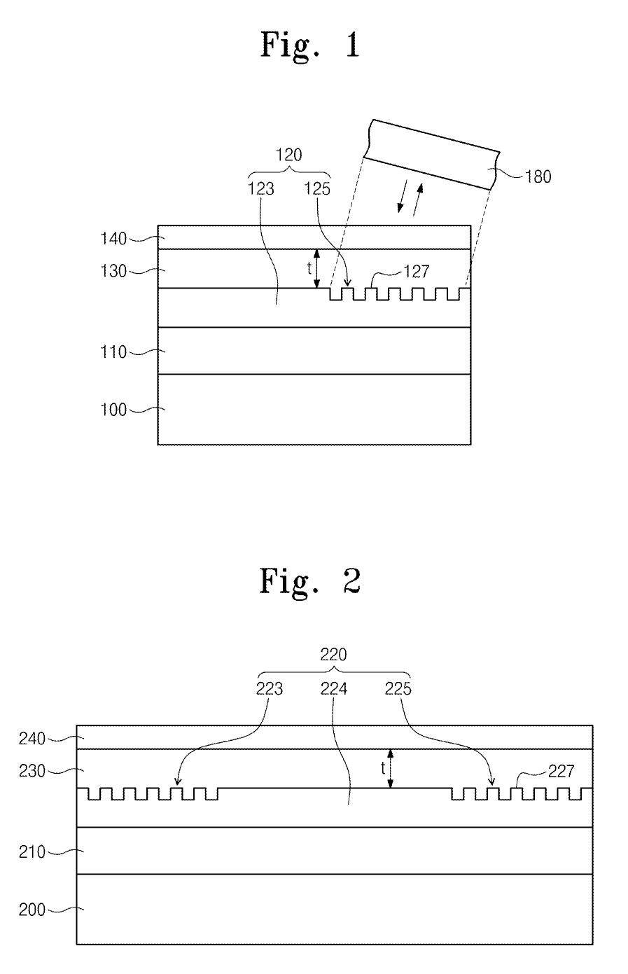

FIG. 1 is a schematic view of an optical coupler according to an embodiment of the inventive concept.

Referring to FIG. 1, a lower cladding layer 110 is disposed on a substrate 100. The substrate 100 may include a silicon substrate. Alternatively, the substrate 100 may include other semiconductor substrates such as a germanium or compound semiconductor substrate. The lower cladding layer 110 may be formed of an insulating material having a refractive index different from that of the substrate 100. For example, the lower cladding layer 110 may be formed of silicon oxide.

A core layer 120 including a diffraction grating coupler 125 and an optical waveguide 123 may be disposed on the lower cladding layer 110. For example, the core layer 120 may be formed of silicon. Alternatively, the core layer 120 may be formed of one of germanium, a silicon-germanium compound, and a compound semiconductor material. The diffraction grating coupler 125 may include a plurality of protrusions 127 spaced from each other on a top surface of the core layer 120. That is, the spaced protrusions 127 may constitute the diffraction grating coupler 125. Both sidewalls of the protrusions 127 may be perpendicular to the substrate 100. The diffraction grating coupler 125 may be disposed at a side of the optical waveguide 123.

A first upper cladding layer 130 is disposed on the core layer 120. A second upper cladding layer 140 is disposed on the first upper cladding layer 130. The core layer 120 has a refractive index greater than that of the first upper cladding layer 130. The first upper cladding layer 130 may have a refractive index greater than that of the second upper cladding layer 140. For example, the first upper cladding layer 130 may comprise silicon and nitrogen. Alternatively, the first upper cladding layer 130 may be formed of silicon nitride or silicon oxide-nitride. For example, the second upper cladding layer 140 may be formed of silicon oxide.

An optical fiber 180 may be disposed on the diffraction grating coupler 125. An optical signal outputted from the optical fiber 180 is transmitted into the optical waveguide 123 via the diffraction grating coupler 125. The optical signal transmitted through the diffraction grating coupler 125 may be reversible. That is, the optical signal may be transmitted from the optical waveguide 123 to the optical fiber 180 via the diffraction grating coupler 125.

An input or output optical signal of the optical fiber 180 may be irradiated in an inclined condition by a predetermined angle with respect to a vertical line of a top surface of the substrate 100. For example, the input or output optical signal of the optical fiber 180 may be irradiated in an inclined condition by an angle of about 5 degrees to about 10 degrees. Alternatively, the input or output optical signal of the optical fiber 180 may travel in a direction perpendicular to that of the top surface of the substrate 100.

A thickness of the first upper cladding layer 130 is determined by a wavelength of the optical signal and the refractive index of the first upper cladding layer 130. The first upper cladding layer 130 has a thickness t of about one quarter of a wavelength of the optical signal divided by a refractive index of the first upper cladding layer 130. That is, the thickness t of the first upper cladding layer 130 should satisfy the following equation: Thickness t=(wavelength/refractive index)×¼. Since the first upper cladding layer 130 having such a thickness t is provided, a Fresnel reflection may be minimized. That is, reflected optical signals generated at an interface between the first upper cladding layer 130 and the other layer may destructively interfere with each other to minimize the Fresnel reflection.

FIG. 2 is a schematic view of an optical coupler according to another embodiment of the inventive concept. This embodiment is similar to the previously described embodiment, except that diffraction grating couplers are disposed at both ends of a waveguide. Thus, for simplification of description, the duplicated description of technical characteristics thereof will be omitted below.

Referring to FIG. 2, a lower cladding layer 210 is disposed on a substrate 200. The substrate may include a silicon substrate. Alternatively, the substrate 200 may include other semiconductor substrates such as a germanium or compound semiconductor substrate. The lower cladding layer 210 may be formed of an insulating material having a refractive index different from that of the substrate 200. For example, the lower cladding layer 210 may be formed of silicon oxide.

A core layer 220 including a first diffraction grating coupler 223, a second diffraction grating coupler 225, and an optical waveguide 224 is disposed on the lower cladding layer 210. The core layer 220 maybe formed of silicon. Alternatively, the core layer 220 may be formed of one of germanium, a silicon-germanium compound, and a compound semiconductor material. The first diffraction grating coupler 223 and the second diffraction grating coupler 225 may include a plurality of protrusions 227 spaced laterally from each other, respectively. That is, the spaced protrusions 227 may constitute the first and second diffraction grating couplers 223 and 225. Both sidewalls of the protrusions 227 may be perpendicular to the substrate 200. The first and second diffraction grating couplers 223 and 225 may be disposed at both ends of the optical waveguide 224. That is, the first diffraction grating coupler 223 may be disposed at one end of the optical waveguide 224, and the second diffraction grating coupler 225 may be disposed at the other end of the optical waveguide 224.

A first upper cladding layer 230 is disposed on the core layer 220. A second upper cladding layer 240 is disposed on the first upper cladding layer 230. The core layer 220 has a refractive index greater than that of the first upper cladding layer 230. The first upper cladding layer 230 may have a refractive index greater than that of the second upper cladding layer 240. An optical fiber or a semiconductor integrated circuit (IC) may be disposed adjacent to the first and second diffraction grating couplers 223 and 225. The first upper cladding layer 230 may be formed of silicon nitride or silicon oxide-nitride. The second upper cladding layer 240 may be formed of silicon oxide.

The first upper cladding layer 230 has a thickness t of about one quarter of a wavelength of the optical signal divided by a refractive index of the first upper cladding layer 130. That is, the thickness t of the first upper cladding layer 230 should satisfy the following equation: Thickness t=(wavelength/refractive index)×¼. Since the first upper cladding layer 230 having such a thickness t is provided, a Fresnel reflection may be minimized That is, reflected optical signals generated at an interface between the first upper cladding layer 230 and the other layer may destructively interfere with each other to minimize the Fresnel reflection.

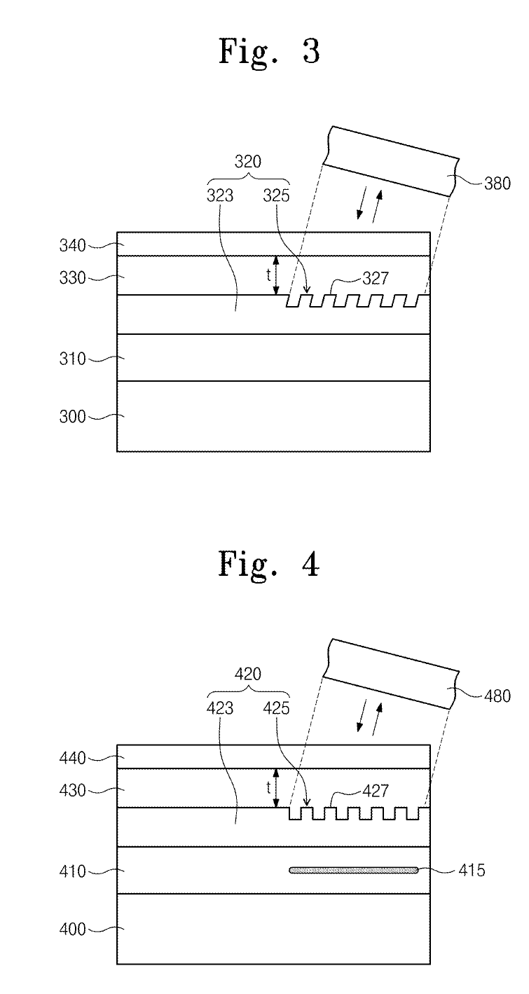

FIG. 3 is a schematic view of an optical coupler according to another embodiment of the inventive concept.

Referring to FIG. 3, a lower cladding layer 310 is disposed on a substrate 300. The substrate 300 may include a silicon substrate. Alternatively, the substrate 300 may include other semiconductor substrates such as a germanium or compound semiconductor substrate. The lower cladding layer 310 may be formed of an insulating material having a refractive index different from that of the substrate 300. For example, the lower cladding layer 310 may be formed of silicon oxide.

A core layer 320 including a diffraction grating coupler 325 and an optical waveguide 323 may be disposed on the lower cladding layer 310. The core layer 320 may be formed of silicon. Alternatively, the core layer 320 may be formed of one of germanium, a silicon-germanium compound, and a compound semiconductor material. The diffraction grating coupler 325 may include a plurality of protrusions 327 spaced laterally from each other. Both sidewalls of the protrusions 327 may be inclined with respect to a top surface of the substrate 300. Since both sidewalls of the protrusions 327 are inclined with respect to the top surface of the substrate 300, coupling efficiency of the diffraction grating coupler 325 may increase. The diffraction grating coupler 325 may be disposed at a side of the optical waveguide 323.

A first upper cladding layer 330 is disposed on the core layer 320. A second upper cladding layer 340 is disposed on the first upper cladding layer 330. The core layer 320 has a refractive index greater than that of the first upper cladding layer 330. The first upper cladding layer 330 may have a refractive index greater than that of the second upper cladding layer 340. The first upper cladding layer 330 may be formed of silicon nitride or silicon oxide-nitride. The second cladding layer 340 may be formed of silicon oxide.

An optical fiber 380 may be disposed on the diffraction grating coupler 325. An optical signal outputted from the optical fiber 380 is transmitted into the optical waveguide 323 via the diffraction grating coupler 325. The optical signal transmitted through the diffraction grating coupler 325 may be reversible. That is, the optical signal may be transmitted from the optical waveguide 323 to the optical fiber 380 via the diffraction grating coupler 325.

An input or output optical signal of the optical fiber 380 may be irradiated in an inclined condition by a predetermined angle with respect to a vertical line of a top surface of the substrate 300. For example, the input or output optical signal of the optical fiber 380 may be irradiated in an inclined condition by an angle of about 5 degrees to about 10 degrees. Alternatively, the input or output optical signal of the optical fiber 380 may travel in a direction perpendicular to that of the top surface of the substrate 300.

A thickness of the first upper cladding layer 330 is determined by a wavelength of the optical signal and the refractive index of the first upper cladding layer 330. The first upper cladding layer 330 has a thickness t of about one quarter of a wavelength of the optical signal divided by a refractive index of the first upper cladding layer 330. That is, the thickness t of the first upper cladding layer 330 should satisfy the following equation: Thickness t=(wavelength/refractive index)×¼. Since the first upper cladding layer 330 having such a thickness t is provided, a Fresnel reflection may be minimized. That is, reflected optical signals generated at an interface between the first upper cladding layer 330 and the other layer may destructively interfere with each other to minimize the Fresnel reflection.

Since both sidewalls of the protrusions 327 are inclined with respect to the top surface of the substrate 300, the coupling efficiency of the diffraction grating coupler 325 may increase.

FIG. 4 is a schematic view of an optical coupler according to a first modified example of the inventive concept.

Referring to FIG. 4, a lower cladding layer 410 is disposed on a substrate 400. The substrate 400 may include a silicon substrate. Alternatively, the substrate 400 may include other semiconductor substrates such as a germanium or compound semiconductor substrate. The lower cladding layer 410 may be formed of an insulating material having a refractive index different from that of the substrate 400. For example, the lower cladding layer 410 may be formed of silicon oxide. A core layer 420 including a diffraction grating coupler 425 and an optical waveguide 423 may be disposed on the lower cladding layer 410.

A reflector 415 is disposed in the lower cladding layer 410. The reflector 415 may have a flat plate shape parallel to a top surface of the substrate 400. The reflector 415 may be formed of a material having a refractive index different from that of the lower cladding layer 410. For example, the reflector 415 may be formed of silicon. The reflector 415 is disposed below the diffraction grating coupler 425. An upper surface of the reflector 415 corresponds to a refractive surface. Unlike the embodiment in FIG. 4, the reflector 415 may include a plurality of sequentially stacked reflectors, each having a plate shape. Coupling efficiency of the diffraction grating coupler 425 may increase by the reflector 415. That is, a portion of the optical signal transmitted via the core layer 420 may be transmitted downwardly from the core layer 420, and the portion of the optical signal transmitted downwardly from the core layer 420 may return again toward the core layer 420 by being reflected by the reflector 415.

The core layer 420 may be formed of silicon. Alternatively, the core layer 420 may be formed of one of germanium, a silicon-germanium compound, and a compound semiconductor material. The diffraction grating coupler 425 may include a plurality of protrusions 427 spaced laterally from each other. That is, the spaced protrusions 427 may constitute the diffraction grating coupler 425. The diffraction grating coupler 425 may be disposed at a side of the optical waveguide 423.

A first upper cladding layer 430 is disposed on the core layer 420. A second upper cladding layer 440 is disposed on the first upper cladding layer 430. The core layer 420 has a refractive index greater than that of the first upper cladding layer 430. The first upper cladding layer 430 may have a refractive index greater than that of the second upper cladding layer 440. The first upper cladding layer 430 may be formed of silicon nitride or silicon oxide-nitride. The second cladding layer 440 may be formed of silicon oxide.

An optical fiber 480 may be disposed on the diffraction grating coupler 425. An optical signal outputted from the optical fiber 480 is transmitted into the optical waveguide 423 via the diffraction grating coupler 425. The optical signal transmitted through the diffraction grating coupler 425 may be reversible. That is, the optical signal may be transmitted from the optical waveguide 423 to the optical fiber 480 via the diffraction grating coupler 425.

An input or output optical signal of the optical fiber 480 may be irradiated in an inclined condition by a predetermined angle with respect to a vertical line of a top surface of the substrate 400. For example, the input or output optical signal of the optical fiber 480 may be irradiated in an inclined condition by an angle of about 5 degrees to about 10 degrees. Alternatively, the input or output optical signal of the optical fiber 480 may travel in a direction perpendicular to that of the top surface of the substrate 400.

A thickness of the first upper cladding layer 430 is determined by a wavelength of the optical signal and the refractive index of the first upper cladding layer 430. The first upper cladding layer 430 has a thickness t of about one quarter of a wavelength of the optical signal divided by a refractive index of the first upper cladding layer 430. That is, the thickness t of the first upper cladding layer 430 should satisfy the following equation: Thickness t=(wavelength/refractive index)×¼. Since the first upper cladding layer 430 having such a thickness t is provided, a Fresnel reflection may be minimized. That is, reflected optical signals generated at an interface between the first upper cladding layer 430 and the other layer may destructively interfere with each other to minimize the Fresnel reflection.

The coupling efficiency of the diffraction grating coupler 425 may increase by the reflector 415. That is, the portion of the optical signal transmitted via the core layer 420 may be transmitted downwardly from the core layer 420, and the portion of the optical signal transmitted downwardly from the core layer 420 may return again toward the core layer 420 by being reflected by the reflector 415.

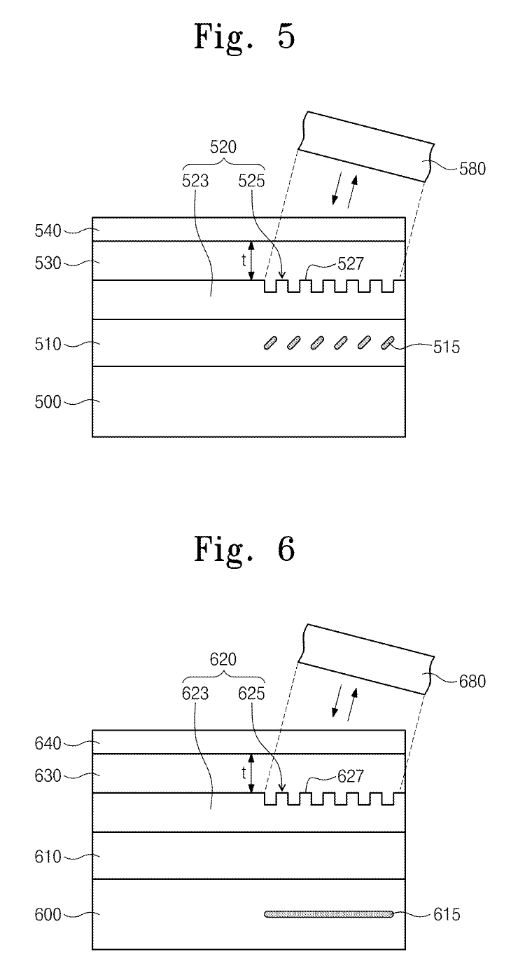

FIG. 5 is a schematic view of an optical coupler according to a second modified example of the inventive concept.

Referring to FIG. 5, a lower cladding layer 510 is disposed on a substrate 500. The substrate 500 may include a silicon substrate. Alternatively, the substrate 500 may include other semiconductor substrates such as a germanium or compound semiconductor substrate. The lower cladding layer 510 may be formed of an insulating material having a refractive index different from that of the substrate 500. For example, the lower cladding layer 510 may be formed of oxide. A core layer 520 including a diffraction grating coupler 525 and an optical waveguide 523 may be disposed on the lower cladding layer 510.

A plurality of reflectors 515 is disposed in the lower cladding layer 510. The reflectors 515 may have the same height and be arranged along one direction parallel to that of a top surface of the substrate 500. The reflectors 515 may be equally spaced along the one direction. The reflectors 515 may be formed of a material having a refractive index different from that of the lower cladding layer 510. For example, the reflectors 515 may be formed of silicon. The reflectors 515 are disposed below the diffraction grating coupler 525. Since the reflectors 515 have inclined refractive surfaces, respectively, optical signals transmitted downwardly from the core layer 520 may effectively return again toward the core layer 520.

The core layer 520 may be formed of silicon. Alternatively, the core layer 520 may be formed of one of germanium, a silicon-germanium compound, and a compound semiconductor material. The diffraction grating coupler 525 may include a plurality of protrusions 527 spaced laterally from each other. That is, the spaced protrusions 527 may constitute the diffraction grating coupler 525. The diffraction grating coupler 525 may be disposed at a side of the optical waveguide 523.

A first upper cladding layer 530 is disposed on the core layer 520. A second upper cladding layer 540 is disposed on the first upper cladding layer 530. The core layer 520 has a refractive index greater than that of the first upper cladding layer 530. The first upper cladding layer 530 may have a refractive index greater than that of the second upper cladding layer 540. The first upper cladding layer 530 may be formed of silicon nitride or silicon oxide-nitride. The second cladding layer 540 may be formed of silicon oxide.

An optical fiber 580 may be disposed on the diffraction grating coupler 525. An optical signal outputted from the optical fiber 580 is transmitted into the optical waveguide 523 via the diffraction grating coupler 525. The optical signal transmitted through the diffraction grating coupler 525 may be reversible. That is, the optical signal may be transmitted from the optical waveguide 523 to the optical fiber 580 via the diffraction grating coupler 525.

An input or output optical signal of the optical fiber 580 may be irradiated in an inclined condition by a predetermined angle with respect to a vertical line of a top surface of the substrate 500. For example, the input or output optical signal of the optical fiber 580 may be irradiated in an inclined condition by an angle of about 5 degrees to about 10 degrees. Alternatively, the input or output optical signal of the optical fiber 580 may travel in a direction perpendicular to that of the top surface of the substrate 500.

A thickness of the first upper cladding layer 530 is determined by a wavelength of the optical signal and the refractive index of the first upper cladding layer 530. The first upper cladding layer 530 has a thickness t of about one quarter of a wavelength of the optical signal divided by a refractive index of the first upper cladding layer 530. That is, the thickness t of the first upper cladding layer 530 should satisfy the following equation: Thickness t=(wavelength/refractive index)×¼. Since the first upper cladding layer 530 having such a thickness t is provided, a Fresnel reflection may be minimized. That is, reflected optical signals generated at an interface between the first upper cladding layer 530 and the other layer may destructively interfere with each other to minimize the Fresnel reflection. That is, reflected optical signals generated at an interface between the first upper cladding layer 530 and the other layer may destructively interfere with each other to minimize the Fresnel reflection.

Since the reflectors 515 have the inclined refractive surfaces, respectively, the optical signals transmitted downwardly from the core layer 520 may more effectively return again toward the core layer 520.

FIG. 6 is a schematic view of an optical coupler according to a third modified example of the inventive concept.

Referring to FIG. 6, a lower cladding layer 610 is disposed on a substrate 600. The substrate 600 may include a silicon substrate. Alternatively, the substrate 600 may include other semiconductor substrates such as a germanium or compound semiconductor substrate. The lower cladding layer 610 may be formed of an insulating material having a refractive index different from that of the substrate 600. For example, the lower cladding layer 610 may be formed of oxide. A core layer 620 including a diffraction grating coupler 625 and an optical waveguide 623 may be disposed on the lower cladding layer 610.

A reflector 615 is disposed in the substrate 600. The reflector 615 may have a flat plate shape parallel to a top surface of the substrate 600. The reflector 615 may be formed of a material having a refractive index different from that of the substrate 600. For example, the reflector 615 may be formed of oxide or nitride. The reflector 615 is disposed below the diffraction grating coupler 625. An upper surface of the reflector 615 corresponds to a refractive surface. Unlike the embodiment in FIG. 6, the reflector 615 may include a plurality of sequentially stacked reflectors, each having a plate shape. Coupling efficiency of the diffraction grating coupler 625 may increase by the reflector 615. That is, a portion of the optical signal transmitted via the core layer 620 may be transmitted downwardly from the core layer 620, and the portion of the optical signal transmitted downwardly from the core layer 620 may return again toward the core layer 620 by being reflected by the reflector 615.

The core layer 620 may be formed of silicon. Alternatively, the core layer 620 may be formed of one of germanium, a silicon-germanium compound, and a compound semiconductor material. The diffraction grating coupler 625 may include a plurality of protrusions 627 spaced laterally from each other. That is, the spaced protrusions 627 may constitute the diffraction grating coupler 625. The diffraction grating coupler 625 may be disposed at a side of the optical waveguide 623.

A first upper cladding layer 630 is disposed on the core layer 620. A second upper cladding layer 640 is disposed on the first upper cladding layer 630. The core layer 620 has a refractive index greater than that of the first upper cladding layer 630. The first upper cladding layer 630 may have a refractive index greater than that of the second upper cladding layer 640. The first upper cladding layer 630 may be formed of silicon nitride or silicon oxide-nitride. The second cladding layer 640 may be formed of silicon oxide.

An optical fiber 680 may be disposed on the diffraction grating coupler 625. An optical signal outputted from the optical fiber 680 is transmitted into the optical waveguide 623 via the diffraction grating coupler 625. The optical signal transmitted through the diffraction grating coupler 625 may be reversible. That is, the optical signal may be transmitted from the optical waveguide 623 to the optical fiber 680 via the diffraction grating coupler 625.

An input or output optical signal of the optical fiber 680 may be irradiated in an inclined condition by a predetermined angle with respect to a vertical line of a top surface of the substrate 600. For example, the input or output optical signal of the optical fiber 680 may be irradiated in an inclined condition by an angle of about 5 degrees to about 10 degrees. Alternatively, the input or output optical signal of the optical fiber 680 may travel in a direction perpendicular to that of the top surface of the substrate 600.

A thickness of the first upper cladding layer 630 is determined by a wavelength of the optical signal and the refractive index of the first upper cladding layer 630. The first upper cladding layer 630 has a thickness t of about one quarter of a wavelength of the optical signal divided by a refractive index of the first upper cladding layer 630. That is, the thickness t of the first upper cladding layer 630 should satisfy the following equation: Thickness t=(wavelength/refractive index)×¼. Since the first upper cladding layer 630 having such a thickness t is provided, a Fresnel reflection may be minimized. That is, reflected optical signals generated at an interface between the first upper cladding layer 630 and the other layer may destructively interfere with each other to minimize the Fresnel reflection.

The coupling efficiency of the diffraction grating coupler 625 may increase by the reflector 615. That is, the portion of the optical signal transmitted via the core layer 620 may be transmitted downwardly from the core layer 620, and the portion of the optical signal transmitted downwardly from the core layer 620 may return again toward the core layer 620 by being reflected by the reflector 615 disposed in the substrate 600.

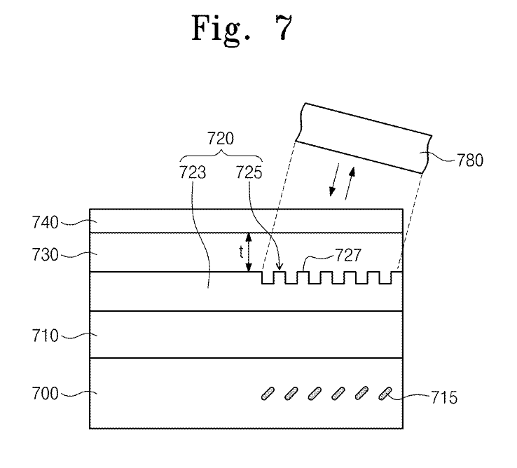

FIG. 7 is a schematic view of an optical coupler according to a fourth modified example of the inventive concept.

Referring to FIG. 7, a lower cladding layer 710 is disposed on a substrate 700. The substrate 700 may include a silicon substrate. Alternatively, the substrate 700 may include other semiconductor substrates such as a germanium or compound semiconductor substrate. The lower cladding layer 710 may be formed of an insulating material having a refractive index different from that of the substrate 700. For example, the lower cladding layer 710 may be formed of oxide. A core layer 720 including a diffraction grating coupler 725 and an optical waveguide 723 may be disposed on the lower cladding layer 710.

A plurality of reflectors 715 is disposed in the substrate 700. The reflectors 715 may have the same height and be arranged along one direction parallel to that of a top surface of the substrate 700. The reflectors 715 may be equally spaced along the one direction. The reflectors 715 may be formed of a material having a refractive index different from that of the substrate 700. For example, the reflectors 715 may be formed of oxide or nitride. The reflectors 715 are disposed below the diffraction grating coupler 725. Since the reflectors 715 have inclined refractive surfaces, respectively, optical signals transmitted downwardly from the core layer 720 may effectively return again toward the core layer 720.

The core layer 720 may be formed of silicon. Alternatively, the core layer 720 may be formed of one of germanium, a silicon-germanium compound, and a compound semiconductor material. The diffraction grating coupler 725 may include a plurality of protrusions 727 spaced laterally from each other. That is, the spaced protrusions 727 may constitute the diffraction grating coupler 725. The diffraction grating coupler 725 may be disposed at a side of the optical waveguide 723.

A first upper cladding layer 730 is disposed on the core layer 720. A second upper cladding layer 740 is disposed on the first upper cladding layer 730. The core layer 720 has a refractive index greater than that of the first upper cladding layer 730. The first upper cladding layer 730 may have a refractive index greater than that of the second upper cladding layer 740. The first upper cladding layer 730 may be formed of silicon nitride or silicon oxide-nitride. The second cladding layer 740 may be formed of silicon oxide.

An optical fiber 780 may be disposed on the diffraction grating coupler 725. An optical signal outputted from the optical fiber 780 is transmitted into the optical waveguide 723 via the diffraction grating coupler 725. The optical signal transmitted through the diffraction grating coupler 725 may be reversible. That is, the optical signal may be transmitted from the optical waveguide 723 to the optical fiber 780 via the diffraction grating coupler 725.

An input or output optical signal of the optical fiber 780 may be irradiated in an inclined condition by a predetermined angle with respect to a vertical line of a top surface of the substrate 700. For example, the input or output optical signal of the optical fiber 780 may be irradiated in an inclined condition by an angle of about 5 degrees to about 10 degrees. Alternatively, the input or output optical signal of the optical fiber 780 may travel in a direction perpendicular to that of the top surface of the substrate 700.

A thickness of the first upper cladding layer 730 is determined by a wavelength of the optical signal and the refractive index of the first upper cladding layer 730. The first upper cladding layer 730 has a thickness t of about one quarter of a wavelength of the optical signal divided by a refractive index of the first upper cladding layer 730. That is, the thickness t of the first upper cladding layer 730 should satisfy the following equation: Thickness t=(wavelength/refractive index)×¼. Since the first upper cladding layer 730 having such a thickness t is provided, a Fresnel reflection may be minimized. That is, reflected optical signals generated at an interface between the first upper cladding layer 730 and the other layer may destructively interfere with each other to minimize the Fresnel reflection.

Since the reflectors 715 disposed in the substrate 700 have the inclined refractive surfaces, respectively, the optical signals transmitted downwardly from the core layer 720 may more effectively return again toward the core layer 720.

In the previously described embodiments, the Fresnel reflection is one of factors that deteriorate performances of an optical communication system. Thus, the Fresnel reflection should be reduced. If the first upper cladding layer has a thickness that does not satisfy the conditions above, the Fresnel reflection occurs on the interface between the core layer and the first upper cladding layer. When an optical signal having a wavelength of about 1550 nm that is widely used in the optical communication system is incident or emitted in a direction inclined by about 8 degrees with respect to a vertical direction of the interface between the core layer and the first upper cladding layer, about 17% of the optical signal incident onto or emitted from the interface may be reflected. When the diffraction grating coupler are integrated with both ends of the core layer performing a specific function to serve as the optical coupler for receiving and transmitting optical signals from/to an optical fiber for communication, a Fabry-Perot interferometer may naturally occur. The undesired Fabry-Perot interferometer should be removed to improve the performances of the optical communication system.

According to the above-described embodiments, the thickness of the first upper cladding layer may minimize the Fresnel reflection and prevent the Fabry-Perot interferometer from occurring. In addition, it may prevent the Fresnel reflection from occurring on the interface between the core layer and the first upper cladding layer even through a refractive index difference between the core layer and the first upper cladding layer is large. Unlike the first upper cladding layer, the second upper cladding layer may not be limited to the thickness thereof. Since the second upper cladding layer is not limited to the thickness thereof, acceptability of a design and manufacturing process of the optical coupler may be greatly enhanced.

According to the embodiments of the inventive concept, the optical coupler includes the upper cladding layer having a predetermined thickness determined by a wavelength of the optical signal and a refractive index thereof. The upper cladding layer has a thickness of about one quarter of the wavelength of the optical signal passing through the upper cladding layer divided by the refractive index thereof. Since the first upper cladding layer having such a thickness is provided, the Fresnel reflection may be minimized, and also, it may prevent the Fabry-Perot interferometer from occurring.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. An optical coupler comprising:
a lower cladding layer on a substrate;
a core layer on the lower cladding layer, the core layer comprising a diffraction grating coupler and an optical waveguide; and
a first upper cladding layer on the core layer,
wherein the first upper cladding layer has a thickness of about one quarter of a wavelength of an optical signal passing through the core layer divided by a refractive index of the first upper cladding layer.

2. The optical coupler of claim 1, further comprising a second upper cladding layer having a refractive index less than that of the first upper cladding layer on the first upper cladding layer.

3. The optical coupler of claim 2, wherein the core layer has a refractive index greater than that of the first upper cladding layer.

4. The optical coupler of claim 3, wherein the core layer is formed of silicon, the first upper cladding layer is formed of silicon nitride or silicon oxide-nitride, and the second upper cladding layer is formed of silicon oxide.

5. The optical coupler of claim 1, wherein the diffraction grating coupler comprises a plurality of protrusions laterally spaced from each other.

6. The optical coupler of claim 1, further comprising a reflector disposed in the lower cladding layer.

7. The optical coupler of claim 6, wherein the reflector has a flat plate shape parallel to a top surface of the substrate.

8. The optical coupler of claim 1, further comprising a reflector disposed in the substrate.

9. The optical coupler of claim 8, wherein the reflector has a flat plate shape parallel to a top surface of the substrate.
